(19) United States
(12) Patent Application Publication
(10) Pub. No.: US 2026/0299659 A1
(43) Pub. Date: Oct. 1, 2026

(54) POWER SUPPLY CAPABLE OF PROVIDING OUTPUT PORT OVER-TEMPERATURE WARNING

(71) Applicant: Wentai Technology Corporation, New Taipei City (TW)

(72) Inventors: Wei-Tang HUANG, New Taipei City (TW); Wei-Chieh HSU, New Taipei City (TW); Yen-Ju LI, New Taipei City (TW); Yi-Ting LIN, New Taipei City (TW); Wei-Jhih LIOU, New Taipei City (TW); Yuan-Liang LIAO, New Taipei City (TW)

(21) Appl. No.: 19/208,029

(22) Filed: May 14, 2025

(30) Foreign Application Priority Data
Mar. 27, 2025 (TW) 114203068

(51) Int. Cl. G06F 1/26; G08B 21/18; H02H 5/04; H02M 3/156

(52) U.S. Cl. CPC G06F 1/26; G08B 21/182; H02H 5/04; H02M 3/156

(57) ABSTRACT

A power supply capable of providing output port over-temperature warning, which includes a control module and an output panel, where the output panel has at least one DC output port and at least one temperature sensing unit, each temperature sensing unit is located adjacent to a corresponding DC output port to provide a temperature signal, and each DC output port is connected to a graphics card of a computer device by means of a power cable; and the control module has at least one warning unit and a control unit, the control unit being electrically coupled with the at least one warning unit and the at least one temperature sensing unit for driving the at least one warning unit to generate at least one warning signal when the temperature signal of one of the at least one temperature sensing unit is above a threshold value.

### BACKGROUND OF THE INVENTION

### Field of the Invention

The invention relates to a power supply, especially to a power supply capable of providing output port over-temperature warning.

### Description of the Related Art

With the increasing popularity of AI (artificial intelligence) applications, many computer devices, including personal computers and servers, have been equipped with AI processors to support the large amount of computations required by AI applications.

However, as the computing power of computer devices increases, the power consumption of the computer devices rises dramatically, making the heat dissipation requirement of the power supplies more demanding. To meet the high heat dissipation requirement of the power supplies, some power supplies have adopted liquid cooling designs to improve heat dissipation performance.

However, with high load currents, the temperatures of the DC power cables and the DC output ports of a power supply can rise dramatically to damage the power supply and the computer device, or even cause a fire.

To solve the aforementioned problems, a novel power supply is needed in the field.

### SUMMARY OF THE INVENTION

The main objective of the invention is to propose a power supply capable of providing output port over-temperature warning, which can generate a warning signal by detecting an over-temperature event of DC output ports to remind the user to take necessary actions to prevent the power supply and a computer device from overheat damages.

Another objective of the invention is to propose a power supply capable of providing output port over-temperature warning, which can further disconnect the output currents of the DC output ports to protect the power supply and a computer device from overheat damages when the over-temperature event is detected.

To attain the aforementioned objectives, a power supply capable of providing output port over-temperature warning is proposed, which includes:
a control module and an output panel electrically coupled with the control module;
where the output panel has at least one DC output port and at least one temperature sensing unit, each temperature sensing unit is located adjacent to a corresponding DC output port to provide a temperature signal, and each DC output port is connected to a graphics card of a computer device by means of a power cable; and
where the control module has a power conversion module, at least one warning unit, and a control unit, the control unit being electrically coupled with the power conversion module, the at least one warning unit, and the at least one temperature sensing unit for driving the at least one warning unit to generate at least one warning signal when the temperature signal of one of the at least one temperature sensing unit is above a threshold value.

In one embodiment, the power conversion module is used to provide at least one DC voltage source to the at least one DC output port.

In one embodiment, the power conversion module includes at least one switching power conversion unit.

In one embodiment, the control unit further disables the power conversion module when the temperature signal of one of the at least one temperature sensing unit is above the threshold value.

In one embodiment, the at least one warning signal includes an audible signal and/or a light signal.

For possible embodiments, the control unit can include a microprocessor or a microcontroller.

For possible embodiments, the computer device can be a personal computer or a server.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is a schematic diagram of a computer device having the power supply capable of providing output port over-temperature warning of the invention;

FIG. 2 is a schematic diagram of the output panel of the power supply capable of providing output port over-temperature warning of the invention; and

FIG. 3 is a block diagram of the control circuit of the control module of the power supply capable of providing output port over-temperature warning of the invention.

### DETAILED DESCRIPTION OF THE PREFERRED EMBODIMENTS

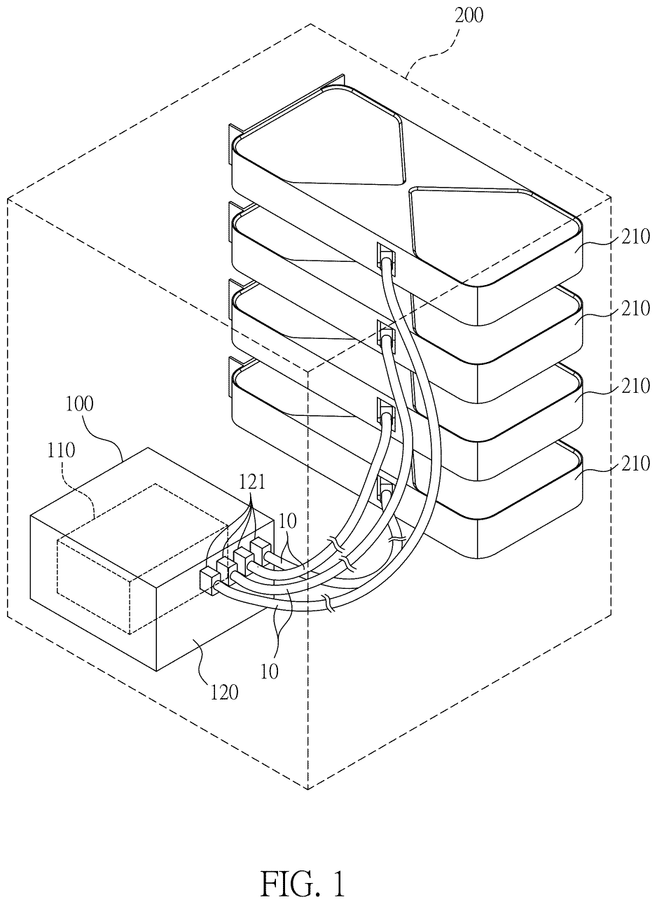

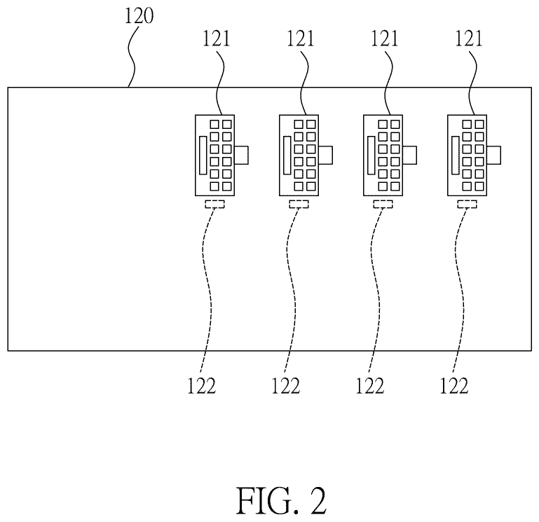

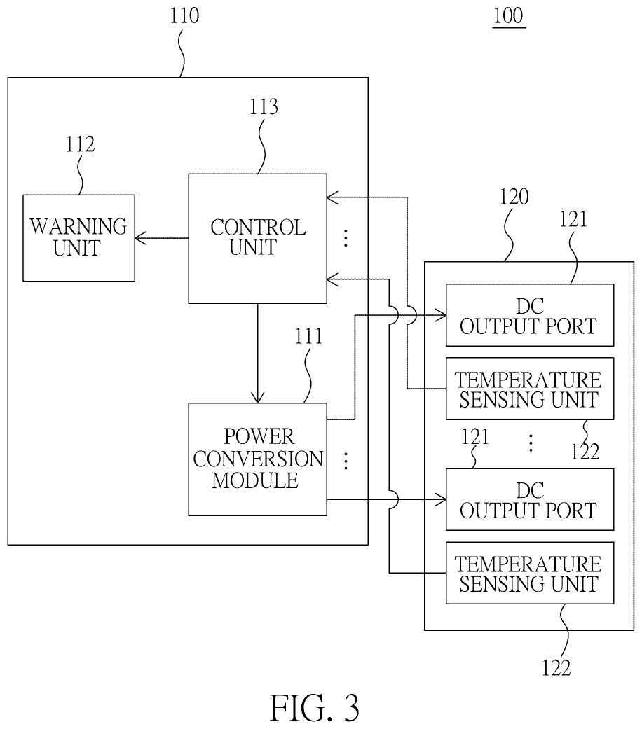

Please refer to FIGS. 1 to 3, where FIG. 1 is a schematic diagram of a computer device having the power supply capable of providing output port over-temperature warning of the invention; FIG. 2 is a schematic diagram of the output panel of the power supply capable of providing output port over-temperature warning of the invention; and FIG. 3 is a block diagram of the control circuit of the control module of the power supply capable of providing output port over-temperature warning of the invention.

As illustrated in FIGS. 1 to 3, a computer device 200, which can be a personal computer or a server, includes a power supply 100 and at least one graphics card 210, the power supply 100 having a control module 110 and an output panel 120 electrically coupled with the control module 110. The output panel 120 has at least one DC output port 121 and at least one temperature sensing unit 122, each temperature sensing unit 122 being adjacent to a DC output port 121, and each DC output port 121 being connected to a graphics card 210 by a power cable 10. The control module 110 has a power conversion module 111, at least one warning unit 112, and a control unit 113, where the control unit 113 is electrically coupled with the power conversion module 111, the at least one warning unit 112, and the at least one temperature sensing unit 122.

The power conversion module 111, which can include at least one switching power conversion unit, is used to provide at least one DC voltage source to the at least one DC output port 121, and each DC output port 121 is used to connect to a graphics card 210 via a power cable 10.

The at least one warning unit 112 is used to provide at least one warning signal to alert a user that an over-temperature event of the DC output port 121, where the at least one warning signal can include an audible signal and/or a light signal, i.e., the warning unit 112 can be an audible warning unit or a light warning unit.

The at least one temperature sensing unit 122 is disposed on the output panel 120 and is each adjacent to a DC output port 121 to provide a temperature signal to detect the temperature of each DC output port 121.

The control unit 113, which can include a microprocessor or microcontroller, is used to drive the at least one warning unit 112 to generate the at least one warning signal when the temperature signal of one of the at least one temperature sensing unit 122 is above a threshold value.

In addition, the control unit 113 can further disable the power conversion module 111 to protect the power supply 100 and the computer device 200 from damages when the temperature signal of one of the at least one temperature sensing unit 122 is above the threshold value.

Based on the foregoing designs, the invention can offer the advantages as follows:
1. The power supply of the invention can generate a warning signal by detecting an over-temperature event of DC output ports to remind the user to take necessary actions to prevent the power supply and a computer device from overheat damages; and
2. The power supply of the invention can further disconnect the output currents of the DC output ports to protect the power supply and a computer device from overheat damages when the over-temperature event is detected.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A power supply capable of providing output port over-temperature warning, which comprises:
a control module; and
an output panel electrically coupled with the control module;
wherein the output panel has at least one DC output port and at least one temperature sensing unit, each said temperature sensing unit is located adjacent to a corresponding said DC output port to provide a temperature signal, and each said DC output port is connected to a graphics card of a computer device by means of a power cable; and
wherein the control module has a power conversion module, at least one warning unit, and a control unit, the control unit being electrically coupled with the power conversion module, the at least one warning unit, and the at least one temperature sensing unit for driving the at least one warning unit to generate at least one warning signal when the temperature signal of one of the at least one temperature sensing unit is above a threshold value.

2. The power supply capable of providing output port over-temperature warning as disclosed in claim 1, wherein the power conversion module is used to provide at least one DC voltage source to the at least one DC output port.

3. The power supply capable of providing output port over-temperature warning as disclosed in claim 2, wherein the power conversion module includes at least one switching power conversion unit.

4. The power supply capable of providing output port over-temperature warning as disclosed in claim 2, wherein the control unit further disables the power conversion module when the temperature signal of one of the at least one temperature sensing unit is above the threshold value.

5. The power supply capable of providing output port over-temperature warning as disclosed in claim 1, wherein the at least one warning signal includes an audible signal and/or a light signal.

6. The power supply capable of providing output port over-temperature warning as disclosed in claim 1, wherein the control unit includes a microprocessor or a microcontroller.

7. The power supply capable of providing output port over-temperature warning as disclosed in claim 1, wherein the computer device is a personal computer or a server.
